(19) United States
(12) Patent Application Publication
(10) Pub. No.: US 2017/0002240 A1
(43) Pub. Date: Jan. 5, 2017

(54) ADHESIVE COMPOSITION BASED ON POLYLACTIDE POLYOLS

(71) Applicant: H.B. Fuller Company, St. Paul, MN (US)

(72) Inventors: Anthony J. Ostlund, Centerville, MN (US); Dorian P. Nelson, St. Paul, MN (US); Wayne G. Eklund, Scandia, MN (US)

(21) Appl. No.: 15/192,321

(22) Filed: Jun. 24, 2016

Related U.S. Application Data
(60) Provisional application No. 62/187,444, filed on Jul. 1, 2015.

(51) Int. Cl. C09J 175/06; B32B 37/12; B32B 7/12

(52) U.S. Cl. CPC C09J 175/06; B32B 7/12; B32B 37/12; B32B 2439/70

(57) ABSTRACT

A two-part laminating adhesive including a Part A polyol component and a Part B isocyanate component. The polyol component includes a polylactide polyol as a first polyol, and the isocyanate component includes an isocyanate-terminated polyurethane prepolymer. The adhesive is suited for making flexible laminates for use in packaging including food packaging.

This application claims the benefit of U.S. Provisional Application No. 62/187,444, filed Jul. 1, 2015, which is incorporated herein.

### BACKGROUND OF THE INVENTION

The present invention is directed to a two-part laminating adhesive, a method of making a laminate, and laminate made thereby.

### SUMMARY OF THE INVENTION

In one aspect, the invention features a two-part laminating adhesive that includes a Part A polyol component and a Part B isocyanate component. The polyol component includes a first polyol that is a polylactide polyol. The Part B is present relative to the Part A at an NCO/OH ratio of at least about 1.

In one embodiment, the isocyanate component includes an isocyanate-terminated polyurethane prepolymer having a final percent isocyanate (NCO%) of from about 4% to about 25%, based on the weight of the prepolymer.

In another aspect, the invention features a method of making a laminate. The laminate includes a first substrate and a second substrate. The method includes combining the Part A and the Part B of the aforementioned laminating adhesive to form an adhesive mixture, applying the adhesive mixture to a surface of the first substrate to form an adhesive bearing surface of the first substrate, and contacting a surface of the second substrate with the adhesive bearing surface of the first substrate to form the laminate.

In yet another aspect, the invention features a laminate including a first substrate, a second substrate, and the first substrate is adhered to the second substrate through the aforementioned laminating adhesive.

### DETAILED DESCRIPTION OF THE INVENTION

The present disclosure relates to a laminating adhesive, a laminate, a packaged food article, and a method of making the laminate using the laminating adhesive.

### Laminating Adhesive

The laminating adhesive is a two-part polyurethane composition that includes a Part A polyol component and a Part B isocyanate component. The two part adhesive composition is a liquid at an ambient temperature, e.g., 77° F., Herein, a composition is considered to be a liquid if it is liquid at an ambient temperature, e.g., 77° F.

The adhesive composition has an initial viscosity of no greater than 4,000 centipoises (cps), or no greater than 3,000 cps, or no greater than 2,000 cps at 105° F. Initial viscosity of the adhesive herein refers to the viscosity determined immediately after Part A and Part B are combined.

The two parts, Part A polyol component and Part B isocyanate component, are kept separate prior to the application, and are mixed immediately before the application in the laminating process. Upon laminating and curing, an adhesive bond forms that adheres the superimposed layers of substrate materials together.

The polyol component (Part A) and the isocyanate component (Part B) are blended together immediately prior to the laminating process such that the equivalent ratio of isocyanate groups (NCO) from the prepolymer (Part B) to the hydroxyl groups (OH) from the polyol (Part A) (i.e., NCO/OH ratio) is at least about 1:1, or in a range from about 1:1 to about 1.5:1, and preferably from about 1:1 to about 1.3:1.

In some embodiments, the adhesive composition is solvent-based. Suitable solvents dissolve or disperse the polymer making a low viscosity solution to facilitate application techniques like spraying, laminating, brushing, and roiling. Examples of common solvents include ethyl acetate, methyl acetate, butyl acetate, acetone, methyl ethyl ketone, methyl amyl ketone, methyl isobutyl ketone, toluene, xylene, and mixtures thereof.

The amount of the solvent varies depending on application equipment and desired coat weight, and ranges from about 10% by weight to about 80% by weight, based on the weight of the adhesive.

In some embodiments, the adhesive composition is substantially free of a solvent, such as no greater than 0.5% solvent. In some embodiments, the adhesive composition is solventless, therefore, it does not include any volatile organic compounds (VOCs).

The adhesive composition has a workable viscosity and pot life, and provides a strong adhesive bond that is comparable to that of the conventional two-part polyurethane adhesives with a much better appearance, which is desirable for food packaging. The adhesive composition can run at higher line speed without stringing.

Part A—polyol component

Part A of the adhesive is a polyol component that preferably has a viscosity of from about 250 cps, or from about 1,000 cps, or from about 2,000 cps to no greater than about 20,000 cps, or no greater than about 15,000 cps, or no greater than about 10,000 cps, or no greater than about 8,000 cps, or no greater than about 5,000 cps at 25° C. In some embodiments, the polyol component is a liquid at an ambient temperature, e.g., 25° C.

In one embodiment, the polyol component includes a first polyol. In the content of the invention, the first polyol herein refers to a polylactide polyol, which can be a single polylactide polyol, or a combination of different polylactide polyols.

In one embodiment, the polyol component also includes an additional polyol that is different from the first polyol, that is, the additional polyol is not a polylactide polyol.

First Polyol

The first polyol refers to a polylactide polyol. The term “first polyol” is interchangeable with the term “polylactide polyol”.

Suitable polylactide polyols include those that have a number average molecular weight (Mₙ) of from about 500 g/mole to about 10,000 g/mole, or from about 500 g/mole to about 2,000 g/mole.

Suitable polylactide polyols also include those that have a hydroxyl (OH) functionality of no greater than 3, or from about 1.5 to about 3, or from about 1.8 to about 2.5.

In some embodiments, the polylactide polyol has a hydroxyl (OH) number of from about 28 mg KOH/g, or from about 100 mg KOH/g, or from about 110 mg KOH/g to about 250 mg KOH/g, or to about 190 mg KOH/g, or to about 170 mg KOH/g, or to about 150 mg KOH/g.

The polyactide polyol can be prepared in various known methods including ring opening addition of lactide to hydroxyl groups of a polyol; esterification of different polyols with lactic acid; or transesterification with esters of lactic acid (e.g., ethyl lactate, butyl lactate).

In some embodiments, the polylactide polyol is a reaction product of a lactide and a hydroxyl-functional initiator.

Lactide is the cyclic di-ester of lactic acid, also known as 2-hydroxypropionic acid. Lactide has different forms such as L-lactide, D-lactide, meso-lactide, racemic lactide, or a mixture thereof, all of which can be used to produce the lactide polyol. Preferred lactide includes meso-lactide or a mixture of L-lactide, D-lactide and meso-lactide.

In some embodiments, the lactide is a mixture of L-lactide, D-lactide and meso-lactide in a molar ratio of meso-lactide to the combination of L-lactide and D-lactide of about 1:1 to about 4:1, preferably, from about 2:1 to about 3:1.

Examples of commercially available lactides include INGEO L100, INGEO M700 and OLYGOS DMR from Natureworks, LLC (Minnetonka, Minn.).

Hydroxyl-functional initiator refers to a multifunctional alcohol that has hydroxyl functionality of from about 1.5 to about 3.5.

Examples of preferred hydroxyl-functional initiators includes glycerol, a fatty acid monoglyceride, a fatty acid diglyceride, and combinations thereof.

Preferably, suitable fatty acids of the fatty acid monoglyceride and fatty acid diglyceride have a saturated or unsaturated aliphatic hydrocarbon chain including from 6 to 32 carbon atoms.

Examples of preferred fatty acids include stearic acid, oleic acid, linoleic acid, and combinations thereof. In some embodiments, glycerol monostearate (GMS) is the most preferred hydroxyl-functional initiator.

Examples of commercially available hydroxyl-functional initiators include distilled glycerol monostearate from ChemPacific (Baltimore, Md).

Additional Polyol

In some embodiments, the polyol component (Part A) may include an additional polyol or mixtures of additional polyols. Suitable additional polyols are liquid at ambient temperature, e.g., 25° C., and may also be referred to as an additional polyol or additional polyols herein.

Suitable additional polyols in Part A include polyether polyols, polyester polyols, polyether/polyester polyols, hydroxyl functional natural oil polyols, and combinations thereof. Suitable additional polyols in Part A have a hydroxyl functionality of at least about 1.5, or at least about 2, or at least about 3, and no greater than about 4, or no greater than about 3.5.

Selection of the additional polyol(s) in Part A is within the constraints that the additional polyol or mixture of additional polyols be liquid at ambient temperature, and that the Part A of the adhesive composition be liquid at ambient temperature. Within these constraints, the hydroxyl number of the additional polyol may vary over a wide range, e.g., from about 25 to about 1,200, and preferably, from about 80 and about 1,000. The additional polyol preferably has a number average molecular weight (Mₙ) of from about 100 to about 5,000 g/mole.

Examples of suitable polyether polyols as additional polyols include those that have a number average molecular weight (Mₙ) of no less than 100 g/mole, or from about 100 g/mole to about 2500 g/mole, such as products obtained from the polymerization of a cyclic oxide, e.g., ethylene oxide, propylene oxide, butylene oxide, and tetrahydrofuran, or by the addition of one or more such oxides polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol and bisphenol A), ethylenediamine, propylenediamine, triethanolamine, and 1,2-propanedithiol. Particularly useful polyether polyols include, e.g., polyoxypropylene diols and triols, poly(oxyethylene-oxypropylene)diols and triols obtained by the simultaneous or sequential addition of ethylene oxide and propylene oxide to appropriate initiators and polytetramethylene ether glycols obtained by the polymerization of tetrahydrofuran.

Examples of preferred polyether polyols as additional polyols include a poly(alkylene oxide), such as poly(propylene oxide), poly(ethylene oxide) or ethylene oxide/propylene oxide copolymer with poly(propylene oxide) most preferred.

Useful polyester polyols as additional polyols are prepared from the reaction product of polycarboxylic acids, their anhydrides, their esters or their halides, and a stoichiometric excess polyhydric alcohol. Suitable polycarboxylic acids include dicarboxylic acids and tricarboxylic acids including, e.g., aromatic dicarboxylic acids, anhydrides and esters thereof (e.g. terephthalic acid, isophthalic acid, dimethyl terephthalate, diethyl terephthalate, phthalic acid, phthatic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthatic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid).

Examples of suitable polyols from which polyester polyols as additional polyols can be derived include aliphatic polyols, e.g., ethylene glycols, propane diols (e.g., 1,2-propanediol and 1,3-propanediol), butane diols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), neopentylglycol, 1,4-cyclohexanedimethanol, 1,4-cyclohexanediol, dimer diols, bisphenol A, bisphenol F, hydrogenated bisphenol A, hydrogenated bisphenol F, polycarprolactone polyols, tetramethylene glycol, polytetramethylene glycol, 3-methyl-1,5-pentanediol, 1,9-nonanediol, 2-methyl-1,8-octanediol, trimethylolpropane, glycerin, pentaerythritol, sorbitol, glucose, and combinations thereof.

Examples of suitable additional polyols in Part A also include natural oil polyols with hydroxyl functionality of from about 1 to about 8, and preferably from about 1.5 to about 4. Examples of suitable natural oil polyol include such as soybean oil, castor oil and rapeseed oil, as well as to those hydroxyl functional compounds that are isolated from, derived from or manufactured from natural oils including animal and vegetable oils, preferably vegetable oils. Examples of vegetable and animal oils that may be used include, but are not limited to, soybean oil, safflower oil, linseed oil, corn oil, sunflower oil, castor oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl functionality. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil).

Examples of suitable polyols from which polycarbonate polyols as additional polyols can be derived include aliphatic polyols, e.g., ethylene glycols, propane diols (e.g., 1,2-propanediol and 1,3-propanediol), butane diols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), neopentyl glycol, 1,4-cyclohexanedimethanol, 1,4-cyclohexanediol, dimer diols, bisphenol A, bisphenol F, hydrogenated bisphenol A, hydrogenated bisphenol F, tetramethylene glycol, polytetramethylene glycol, 3-methyl-1,5-pentanediol, 1,9-nonanediol, 2-methyl-1,8-octanediol, trimethylolpropane, glycerin, pentaerythritol, sorbitol, glucose, and combinations thereof, as well as polyols derived from organic oxides such as ethylene oxide and propylene oxide.

Examples of other suitable additional polyols in Part A include polyether/polyester polyols as well as mixtures of the aforementioned polyether polyols, polyester polyols, polyether/polyester polyols, and natural oil polyols.

Catalyst

The laminating adhesive may optionally include a catalyst. In one embodiment, the catalyst is included in the polyol component (Part A).

Examples of suitable catalysts include tin, iron, zinc and aluminum organic salts, mineral or organic acids, and basic catalysts.

Preferably, the catalyst is a tin catalyst including tin (II) ethylhexanoate (SnOct₂), and dibutyl tin dilaurate.

Part B—isocyanate component

The isocyanate component in Part B preferably has a viscosity of from about 2,000 cps to no greater than 15,000 cps, or no greater than 10,000 cps, or no greater than 8000 cps at 25° C.

In some embodiments, the isocyanate component is selected to be liquid at an ambient temperature, e.g., 25° C.

The isocyanate component may simply be a polyisocyanate, such as 4,4′-diphenylmethane diisocyanate (MDI) and its isomers, toluene diisocyanate (TDI), xylene diisocyanate (XDI), hexamethylene diisocyanate (HDI), isophorone diisocyanate, tetramethylxylene diisocyanate, modified diphenylmethane diisocyanate such as carbodiimide-modified diphenylmethane diisocyanate, allophanate-modified diphenylmethane diisocyanate, biuret-modified diphenylmethane diisocyanate, polymeric diphenylmethane diisocyanate, etc., and combinations thereof.

It is preferred that the isocyanate component be an isocyanate-terminated polyurethane prepolymer formed by reacting a polyol, such as any of the aforementioned polyols suitable as the first polyol as well as the additional polyols in the Part A of the adhesive, with a polyisocyanate, such as any of those mentioned above.

For the sake of clarity, the polyol(s) in Part A used to form the adhesive may be referred to as a first polyol and an additional polyol or additional polyols, the polyol reacted with the polyisocyanate to form the prepolymer in Part B may be referred to as a second polyol. It is understood that the second polyol used to form the prepolymer can be the same polyol as the first polyol and/or as any additional polyol in Part A, or it can be a different polyol from the first polyol and any additional polyols in Part A. The second polyol can be selected from the same list of polyols described above for the polyols including the first polyol and the additional polyols in Part A.

In one embodiment, the second polyol is also a polylactide polyol.

In one embodiment, the second polyol is the same or different polylactide polyol as the first polyol in Part A.

To ensure that the polyurethane prepolymer is isocyanate-terminated, the NCO/OH ratio of the polyisocyanate and the second polyol is from about 2:1, or from about 4:1, or from about 6:1, to about 8:1.

The prepolymer preferably has a final percent isocyanate (NCO%) of from about 4%, or from about 6% or from about 10%, or even from about 15% to about 25%, based on the weight of the prepolymer.

The prepolymer is preferably a liquid at ambient temperature, and has a viscosity that allows it to be easily processed. In some embodiments, the prepolymer has a viscosity of from about 2,000 cps, or about 4,000 cps, to no greater than 15,000 cps, or no greater than 10,000 cps at 25° C.

Other Additives

The adhesive composition may also include other optional additives in either Part A or Part B, or added additionally other than premixed with either Part, which include, e.g., antioxidants, plasticizers, adhesion promoters, catalysts, catalyst deactivators, rheology modifiers, colorants (e.g., pigments and dyes), surfactants, waxes, and mixtures thereof.

The adhesive may optionally include thermoplastic polymers including e.g., ethylene vinyl acetate, ethylene-acrylic acid, ethylene methacrylate and ethylene-n-butyl acrylate copolymers, polyether/polyester e.g., HYTREL material, polyvinyl alcohol, hydroxyethylcellulose, hydroxylpropylcellulose, polyvinyl methyl ether, polyethylene oxide, polyvinylpyrrolidone, polyethyloxazolines, starch, cellulose esters, and combinations thereof.

Laminate

The laminate of the invention includes at least a first substrate, a second substrate, and any one of the aforementioned adhesive compositions laminated between the two substrates. The first and the second substrates may be of the same or a different material. Preferably, the first and/or the second substrate is/are a flexible film.

The laminate may be a multi-layer laminate, which has more than two substrates laminated together with any one of the aforementioned adhesive compositions in between each of the two layers.

The disclosed adhesive composition can be used with a variety of substrates and in particular flexible films including, e.g., metal foils (aluminum foil), polymer films and metalized polymer films prepared from polymers including, e.g., polyolefins (e.g., polypropylene, polyethylene, low density polyethylene, linear low density polyethylene, high density polyethylene, polypropylene, and oriented polypropylene; copolymers of polyolefins and other comonomers), metalized polyolefins (e.g., metalized polypropylene), metalized polyethylene terephthalate, ethylene-vinyl acetates, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, polylactic acid, cellulosics, polystyrene, cellophane, paper, and retortable packaging laminate materials. The thickness of a film may vary, but flexible films typically have a thickness of less than about 0.25 millimeters, e.g. from about 5 micrometers to about 150 micrometers, more typically from about 8 micrometers to about 100 micrometers. The surface of the substrate can be surface treated to enhance adhesion using any suitable method including, e.g., corona treatments, chemical treatments and flame treatments.

Other suitable substrates include, e.g. woven webs, non-woven webs, paper, paperboard, and cellular flexible sheet materials (e.g., polyethylene foam, polyurethane foam and sponge and foam rubber). Woven and non-woven webs can include fibers including, e.g., cotton, polyester, polyolefin, polyamide, and polyimide fibers. The substrate can be constructed to exhibit many useful properties. Preferably the substrate exhibits properties useful for flexible packaging and retortable packaging. Such properties include, e.g., high tensile strength, vapor barrier properties, flexibility, rigidity, resistance to thermal degradation and combinations thereof. The disclosed adhesive compositions are especially suited for manufacturing flexible packaging and in particular flexible food packaging.

### Methods of Making and Using

Any suitable method of making flexible laminates can be used to make the laminate of the invention. One useful method includes applying the adhesive in the liquid form to a first substrate, e.g., a flexible film, then contacting a second substrate, e.g., a same or different flexible film with the adhesive bearing surface of the first substrate such that the two substrates are bonded together to form a laminate.

In some embodiments, the adhesive composition may be applied using any suitable coating process including, e.g., air knife, trailing blade, spraying, brushing, dipping, doctor blade, roll coating, multi-roll transfer coating, gravure coating, offset gravure coating, rotogravure coating, or combinations thereof. Useful coating temperatures range from about 20° C. to about 50° C. Lower temperatures are preferred during the solventless laminating process in order to extend the working life of the adhesive composition. The coating weight of the adhesive may vary broadly depending on the properties desired of the laminate. Useful adhesive coating weights include, e.g., from about 0.8 grams per square meter (gsm) to about 6.5 gsm, or even from about 0.8 gsm to 2.5 gsm. Once coated, the first film substrate is contacted with a second film substrate. The second substrate may be of the same or different material relative to the first substrate. To make a multi-layered laminate, the laminating procedure herein described may be repeated a number of times, so that it is possible to produce laminates which consist of more than two bonded layers. In some embodiments, when manufacturing flexible laminates, the disclosed adhesive composition can be processed on laminator units at line speeds up to about 1000, or up to about 1500, or even up to about 2000 feet/min.

The resulting laminates can be converted into various packaging products, especially food packaging products, e.g., bags, pouches, stand-up pouches, zippered pouches, etc.

While the disclosed adhesive compositions are useful for making laminates for use in food packaging products, it is understood that they can be used to make laminates that can be used to make other packaging products for a variety of purposes, including packaging for industrial applications, packaging for consumer applications such as cleaning products, cosmetics, and health and beauty products, packaging for agricultural and veterinary applications such as feed, pesticides, and soil, packaging for medical and pharmaceutical applications, and use in photovoltaic structures, flexible electronic assemblies, general industrial laminates, and flexible optical displays.

The present disclosure may be better understood with reference to the following examples. These examples are intended to be representative of specific embodiments of the disclosure and are not intended to be limiting to the scope of the disclosure.

All parts, ratios, percents, and amounts stated herein and in the examples are by weight unless otherwise specified.

### EXAMPLES

Test Methods

### Viscosity

The viscosity is determined using a Brookfield Programmable Rheometer Model DV-III using Spindle #27 at 20 RPM and about 10.5 gram (g) of sample material at 25° C.±1° C. and 40° C.±1° C.

### Initial Viscosity

Initial viscosity of an adhesive is determined using a Brookfield Programmable Rheometer Model DV-III using Spindle #27 at 20 RPM, and about 10.5 gram (g) of sample material at 40° C.±1° C.

### Average Molecular Weight

Weight average molecular weight (M_{w}) and number average molecular weight (Mₙ) are determined according to ASTM D 5296-05 entitled “Standard Test Method for Molecular Weight Averages and Molecular Weight Distribution of Polystyrene by High Performance Size Exclusion Chromatography.

### Glass Transition Temperature (Tg)

Glass transition temperature (Tg) is determined by ASTM D3418-03 entitled “Standard Test Method for Transition Temperatures and Enthalpies of Fusion and Crystallization of Polymers by Differential Scanning Calorimetry”.

### Hydroxyl (OH) Number

Hydroxyl number (OH number) is determined by ASTM E 222-00 entitled “Standard Test Method for Hydroxyl Groups Using Acetic Anhydride Acetylation”.

### Percent Isocyanate (NCO%)

Percentage isocyanate (NCO%) of a prepolymer is determined by ASTM D2572-97 entitled “Standard Test Method for Isocyanate Groups in Urethane Materials or Prepolymers”.

### Peel Adhesion Test

Peel adhesion test is conducted on a laminate placed in a controlled 25° C./50% relative humidity room to cure after lamination and during the testing window using a Thwing-Albert Friction/Peel Tester Model 225-1. Prior to the test, a laminate made of two substrates bonded through an adhesive composition at a coat weight of from about 1.2 gsm to about 2 gsm is cut into 25 mm×250 mm sample strips. Each of the strips is separated at one end and then peeled at a speed of 300 mm/minute for 20 seconds. The peel strength in g/25 mm is recorded. An average of three (3) samples is reported.

### Examples

### Polyol Component

The following polyol components were used as Part A for making the adhesives to be tested in the Examples.

### Polyol Component 1 (PC-1)

A polylactide polyol was prepared by reacting 2157 grams of OLYGOS® DMR (a mixture of meso-, L-, and D-lactides at a ratio of meso-lactide to combined L- & D-lactides at 2:1) with 1342 grams of glycerol monostearate (from ChemPacific) at 248° F. for 4 hours in the presence of 1.5 grams of DABCO® T-9 ((Sn(Oct)₂, catalyst from Air Product). After 4 hours, the catalyst was neutralized with an equal weight of H₃PO₄ (85% aq.) and the mixture was sparged with dry nitrogen gas for 1 hour at 248° F. The viscosity of the resultant polylactide polyol was measured to be about 2,650 cps at 40° C. The weight average molecular weight (M_{w}) was measured to be about 1,000 g/mole, and the hydroxyl (OH) number is 120. The resultant polylactide polyol was a semi-solid at 25° C.

### Polyol Component 2 (PC-2)

Polyol Component 2 was prepared by mixing PC-1 with dipropylene glycol (DPG) in a weight ratio of 90:10 PC-1:DPG. The viscosity of the PC-2 was measured to be 8,113 cps at 25° C. and 1,063 cps at 40° C.

### Polyol Component 3 (PC-3)

Polyol Component 3 was prepared by mixing PC-1 with polypropylene glycol (PPG, MW: 2000, OH number: 56.1) in a weight ratio of 90:10 PC-1:PPG. The viscosity of the PC-3 was measured to be 1,675 cps at 40° C. The PC-3 is a semi-solid at 25° C.

### Polyol Component 4 (PC-4)

Polyol Component 4 was prepared by mixing PC-1 with VORANOL® 230-238 (PPG, from Dow Chemical) in a weight ratio of 90:10 PC-1:PPG. The viscosity of the PC-4 was measured to be 15,900 cps at 25° C. and 1,788 cps at 40° C.

### Prepolymer A (P-A)

Prepolymer A was prepared by reacting 1146 grams of the polylactide polyol made as described above as PC-1 with 1854 grams of MONDUR® MLQ (50/50 mixture of 2,4′- and 4,4′-MDI, from Bayer) at NCO/OH ration of 5.65:1 at 75° C. for 1.5 hours. The final percent isocyanate was measured at 17.68% and the viscosity was 9,012 cps at 25° C. and 1,337 cps at 40° C.

### Prepolymer B (P-B)

Prepolymer B was prepared by reacting a mixture of 143 grams polypropylene glycol (PPG, MW: 2000, OH number: 56.1) and 563 grams of PC-1 with 1093 grams of MONDUR® MLQ (50/50 mixture of 2,4′- and 4,4′-MDI) at NCO/OH ratio of 6.10:1 at 75° C. for 1.5 hours. The final percent isocyanate was measured at 17.68% and the viscosity was 4,977 cps at 25° C. and 887.5 cps at 40° C.

### Examples 1-5

Each adhesive composition of Examples 1-5 was prepared by combining Part A and Part B, according to Table 1, at an NCO/OH ratio of 1.25:1 and room temperature prior to the lamination.

TABLE 1

| | | | Initial |
|---|---|---|---|
| | Part A | Part B | Viscosity (cps |
| | (grams) | (grams) | at 40° C.) |
| Ex. 1 | PC-1 (500) | P-A (427) | 2250 |
| Ex. 2 | PC-2 (500) | P-A (527) | 1863 |
| Ex. 3 | PC-3 (500) | P-A (332) | 1975 |
| Ex. 4 | PC-4 (500) | P-A (370) | 2138 |
| Ex. 5 | PC-2 (500) | P-B (527) | 1438 |

### Example 6 (Laminate)

Laminates of various film substrates were prepared by applying an adhesive according to Table 2 at a coat weight of from about 1.2 gsm to about 2 gsm to a major surface of a first film substrate according to Table 2 at an application temperature of 105° F. via roll-to-roll coating. The adhesive-bearing film substrate was then laminated to a second film substrate according to Table 2. The peel strength of each laminate was measured according to the herein described Peel Adhesion test method within 24 to 72 hours of lamination. The test results are also shown in Table 2.

TABLE 2

| First substrate | Second substrate | Adhesive | Peel Strength |
|---|---|---|---|
| OPP | OPP | Control* | Destruct** |
| PET | PE | Control* | Destruct |
| OPP | OPP | 1 | Destruct |
| PET | PE | 1 | Destruct |
| OPP | OPP | 2 | Destruct |
| PET | PE | 2 | Destruct |
| OPP | OPP | 3 | Destruct |
| PET | PE | 3 | Destruct |
| OPP | OPP | 4 | Destruct |
| PET | PE | 4 | Destruct |
| OPP | OPP | 5 | Destruct |
| PET | PE | 5 | Destruct |

*Fiextra Fast ™ WD4120/XR1500, Commercially available from HB Fuller (St. Paul, MN)
** Destruct means that the substrate(s) tore before the adhesive bond failed,
OPP: oriented polypropylene
PET: polyethylene terephthalate
PE: polyethylene

Table 2 shows that the adhesives of the invention exhibited very good adhesion with a variety of substrates.

The above specification, examples and data provide a complete description of the disclosure. Since many embodiments can be made without departing from the spirit and scope of the disclosure, the invention resides in the claims hereinafter appended.

We claim:

1. A two-part laminating adhesive comprising
Part A, a polyol component comprising a first polyol that is a polylactide polyol, and
Part B, an isocyanate component
the Part B being present relative to the Part A at an NCO/OH ratio of at least about 1.

2. The adhesive of claim 1, wherein the potylactide polyol is a reaction product of a facade and a hydroxyl-functional initiator selected from the group consisting of glycerol, a fatty acid monoglyceride, a fatty acid diglyceride, and combinations thereof.

3. The adhesive of claim 1, wherein the polyactide polyol has a number average molecular weight of from about 500 g/mole to about 10,000 g/mole.

4. The adhesive of claim 1, wherein the polylactide polyol has a hydroxyl (OH) functionality of no greater than 3.

5. The adhesive of claim 2, wherein the fatty acid of the fatty acid monoglyceride and the fatty acid diglyceride has a saturated or unsaturated aliphatic hydrocarbon chain comprising from 6 to 32 carbon atoms.

6. The adhesive of claim 2, wherein the fatty acid of the fatty acid monoglyceride and the fatty acid diglyceride is selected from stearic acid, oleic acid, linoleic acid, and combinations thereof.

7. The adhesive of claim 1, wherein the polyol component further comprises an additional polyol that is different from the polylactide polyol.

8. The adhesive of claim 1, wherein the polyol component further comprises and additional polyol selected from the group consisting of dipropylene glycol, polypropylene glycol, diethylene glycol adipate, and combinations thereof.

9. The adhesive of claim 1, wherein Part B is present relative to Part A at an NCO/OH ratio of from about 1:1 to about 1.5:1.

10. The adhesive of claim 1, wherein Part A has a viscosity of no greater than 20,000 cps at 25° C.

11. The adhesive of claim 1, wherein Part B has a viscosity of no greater than 10,000 cps at 25° C.

12. The adhesive of claim 1, wherein Part A further comprising a catalyst.

13. The adhesive of claim 1, wherein the isocyanate component is an isocyanate-terminated polyurethane prepolymer that is a reaction product of a second polyol and a polyisocyanate, the prepolymer having a percentage isocyanate (NCO%) of from about 4% to about 25% based on the weight of the prepolymer.

14. The adhesive of claim 13, wherein the second polyol is a polylactide polyol.

15. A method of making a laminate that comprises a first substrate and a second substrate, the method comprising
Preparing an adhesive mixture by combining the Part A and the Part B of the two-part, adhesive of claim 1,
applying the adhesive mixture to a surface of the first substrate to form an adhesive bearing surface of the first substrate, and
contacting a surface of the second substrate with the adhesive bearing surface of the first substrate to form the laminate.

16. The method of claim 15, wherein the first and the second substrates are the same or different material, at least one of the first and the second substrates comprises polyethylene, polypropylene, polyester, polylactic acid, nylon, ethylene-methacrylic acid ionomers, aluminum foil, metalized material, paper, laminates thereof, and combinations thereof.

17. The method of claim 15, further comprising curing the adhesive mixture.

18. A laminate, comprising
a first substrate, and
a second substrate,
the first substrate being adhered to the second substrate through the adhesive of claim 1,

19. The laminate of claim 18, wherein the first and the second substrates are the same or different material, at least one of the first and the second substrates comprises polyethylene, polypropylene, polyester, polylactic acid, nylon, ethylene-methacrylic acid ionomers, aluminum foil, metalized material, paper, laminates thereof, and combinations thereof.

20. A packaged food article, comprising
a laminate of claim 19 in a form of a food package, and
a food product contained inside of the food package.
